(19) United States
(12) Patent Application Publication
(10) Pub. No.: US 2019/0197856 A1
(43) Pub. Date: Jun. 27, 2019

(54) Warning System

(71) Applicant: Tommy Gracin, Glen Cove, NY (US)

(72) Inventor: Tommy Gracin, Glen Cove, NY (US)

(21) Appl. No.: 15/850,863

(22) Filed: Dec. 21, 2017

(51) Int. Cl. G08B 17/103; G08B 17/113; G08B 29/18; G08B 25/00

(52) U.S. Cl. CPC G08B 17/103; G08B 17/113; G08B 29/26; G08B 25/009; G08B 29/185

(57) ABSTRACT

A warning system for alerting a nearby person to the presence of fire or carbon monoxide includes a housing that has an air intake that extends into an interior of the housing to allow ambient air into the housing. A processor is mounted in the housing. An alerting assembly is mounted on the housing and emits an alert that is to be detected by a person. The alerting assembly is electrically coupled to the processor and emits the alert when the processor sends an alert signal to the alerting assembly. A sensor is mounted in the housing and is in fluid communication with the air intake. The sensor tests the ambient air for an alert agent and sends a detection signal to the processor when the sensor detects the alert agent wherein the processor sends the alerting assembly the alert. A power supply is electrically coupled to the processor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to alerting systems and more particularly pertains to a new alerting system for alerting a nearby person to the presence of fire or carbon monoxide.

### BRIEF SUMMARY OF THE INVENTION

An embodiment of the disclosure meets the needs presented above by generally comprising a housing that has a front wall, a back wall and a perimeter wall that extends between and is attached to the front wall and the back wall. The housing has an air intake that extends into an interior of the housing to allow ambient air into the housing. A processor is mounted in the housing. An alerting assembly is mounted on the housing and emits an alert that comprises a detectable audio or visual output configured to be detected by a person. The alerting assembly is electrically coupled to the processor and emits the alert when the processor sends an alert signal to the alerting assembly. A sensor is mounted in the housing and is in fluid communication with the air intake. The sensor tests the ambient air for an alert agent and sends a detection signal to the processor when the sensor detects the alert agent. The processor sends the alerting assembly the alert when the processor receives the detection signal. A transmitter is mounted in the housing and is electrically coupled to the processor. The transmitter is configured to be in communication with an extrinsic communication network to contact emergency response personnel. A power supply is coupled to the housing and electrically coupled to the processor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front side view of a warning system according to an embodiment of the disclosure.

FIG. 2 is a back view of an embodiment of the disclosure.

FIG. 3 is a front view of an embodiment of the disclosure.

FIG. 4 is a side view of an embodiment of the disclosure.

FIG. 5 is a schematic block diagram of an embodiment of the disclosure.

### DETAILED DESCRIPTION OF THE INVENTION

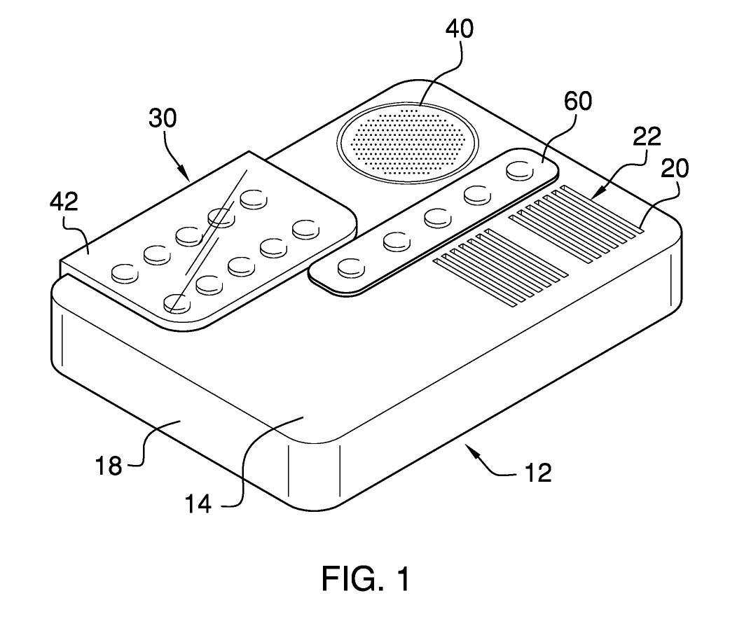

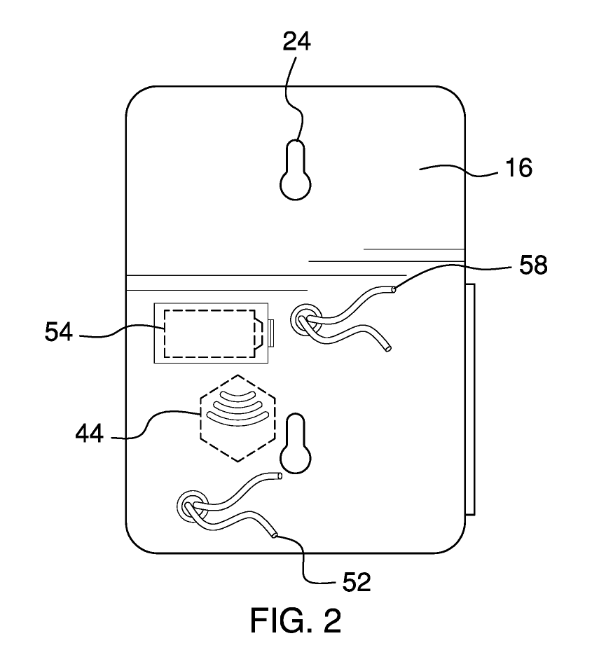

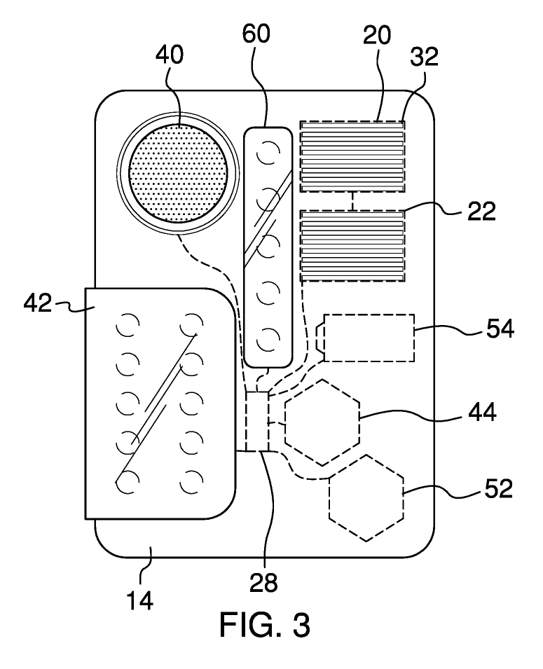

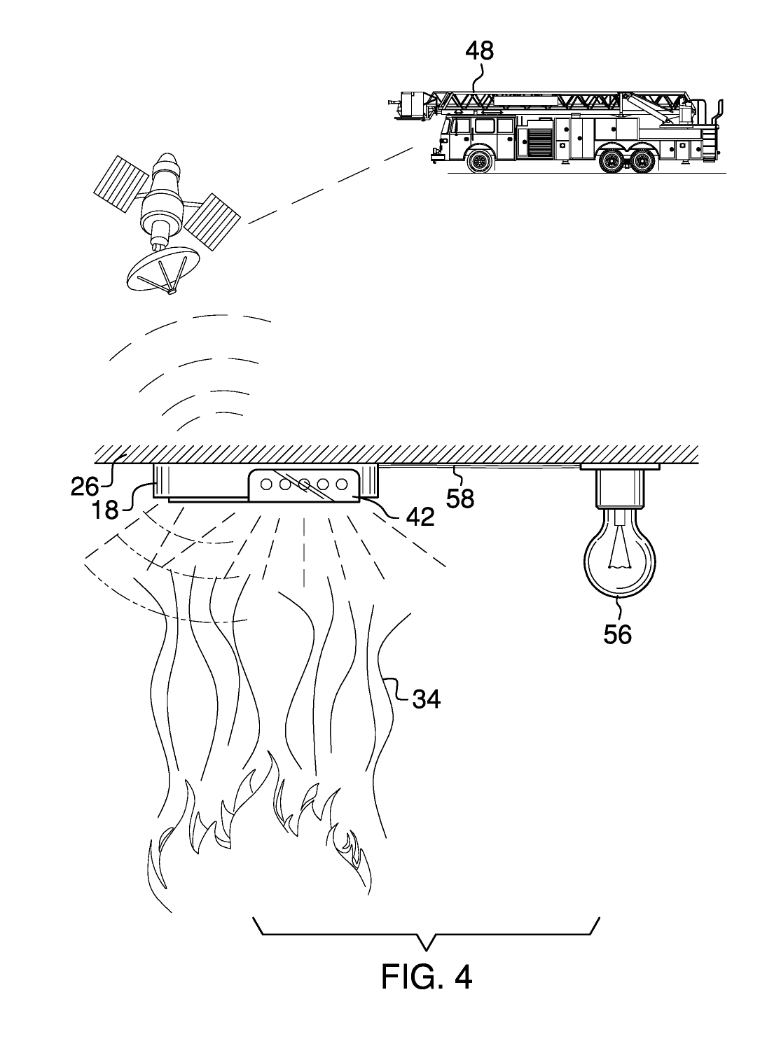

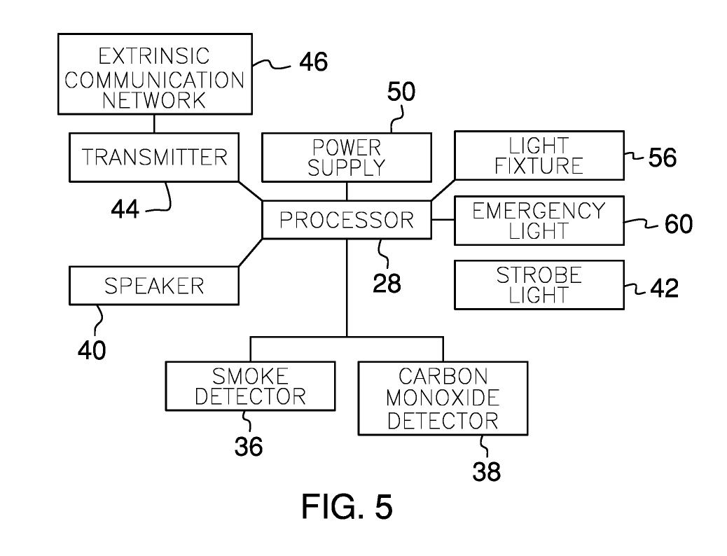

With reference now to the drawings, and in particular to FIGS. 1 through 5 thereof, a new alerting system embodying the principles and concepts of an embodiment of the disclosure and generally designated by the reference numeral 10 will be described.

As best illustrated in FIGS. 1 through 5, the warning system 10 generally comprises a housing 12 that has a front wall 14, a back wall 16 and a perimeter wall 18 that extends between and is attached to the front wall 14 and the back wall 16. The housing 12 has an air intake 20 that extends into an interior 22 of the housing 14 to allow ambient air into the housing 12. The back wall 16 has a mount 24 thereon that engages a coupler that is positioned on a wall surface 26.

A processor 28 is mounted in the housing 12. An alerting assembly 30 is mounted on the housing 12 and emits an alert that comprises a detectable audio or visual output to be detected by a person. The alerting assembly 30 is electrically coupled to the processor 28 and emits the alert when the processor 28 sends an alert signal to the alerting assembly 30.

A sensor 32 is mounted in the housing 12 and is in fluid communication with the air intake 20. The sensor 32 tests the ambient air for an alert agent and sends a detection signal to the processor 28 when the sensor 32 detects the alert agent. The processor 28 sends the alerting assembly 30 the alert when processor 28 receives the detection signal. The alert agent is smoke 34 or carbon monoxide. The sensor includes a smoke detector 36 and a carbon monoxide detector 38 that are mounted in the housing.

The alerting assembly 30 includes a speaker 40 that emits a smoke alarm when the sensor 32 detects smoke 34 and emits a carbon monoxide alarm when the sensor 32 detects carbon monoxide. The smoke alarm and the carbon monoxide alarm each may comprise a human voice that alerts the nearby person to the specific alert agent detected, but may be any alarm suitable to warn the person of the alert agent. The alerting assembly 30 also includes a strobe light 42 that emits light outwardly from the housing 12 when the alerting assembly 30 receives the alert signal.

A transmitter 44 is mounted in the housing 12 and is electrically coupled to the processor 28. The transmitter 44 is in communication with an extrinsic communication network 46 to contact emergency response personnel 48. The transmitter 44 communicates with the extrinsic communication network 46 when the transmitter 44 receives a transmit signal from the processor 28. The processor 28 sends the transmit signal after the processor 28 receives the detection signal. The processor 28 may delay sending the transmit signal until the detection signal has been received from the sensor 32 for at least a threshold period of time to prevent a false warning. The extrinsic communication network 46 may comprise a security system of a dwelling or other monitoring system in communication with a dwelling. The term dwelling includes buildings for living in as well as workplaces and other human occupied structures.

A power supply 50 is coupled to the housing 12 and electrically coupled to the processor 28. The power supply 50 includes a first power source 52 that includes a power inlet that is electrically coupled to an electrical power system of a dwelling. The power supply includes a second power source 54 that comprises a battery. The battery supplies power to the processor 28 when the processor 28 detects a lack of electrical power from the first power source 52.

A light fixture 56 is remotely positioned with respect to the housing 12. A power outlet 58 extends outwardly from the housing 12 and is electrically coupled to the processor 28 and to the light fixture 56. The processor 28 turns on the light fixture 56 when the processor 28 detects a lack of electrical power from the first power source 52. An emergency light 60 is coupled to the housing 12 and electrically coupled to the processor 28. The emergency light 60 is turned on when the processor 28 detects a lack of electrical power from the first power source 52.

In use, the housing 12 is mounted onto the wall surface 26. The first power source 52 is electrically coupled to the buildings electrical power system. The power outlet 58 is electrically coupled to the light fixture 56. The sensor 32 is in fluid communication with the air intake 20. When smoke 34 or carbon monoxide flow into the air intake 20 the sensor 32 detects the alert agent and sends the detection signal to the processor 28. The processor 28 sends the alert signal to the speaker 40 and the corresponding alarm is emitted from the speaker 40. The processor 28 also sends the alert signal to the strobe light 42 to turn the strobe light 42 on. In the event that the first power source 52 no longer sends electrical power to the processor 28 the second power source 54 supplies power to the processor 28. When the second power source 54 powers the processor 28, the processor 28 turns on the light fixture 56 and the emergency light 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An alarm system configured to alert a person to an emergency condition, said alarm system comprising:
a housing having a front wall, a back wall and a perimeter wall extending between and being attached to said front wall and said back wall, said housing having an air intake extending into an interior of said housing to allow ambient air into said housing;
a processor being mounted in said housing;
an alerting assembly being mounted on said housing and emitting an alert comprising a detectable audio or visual output configured to be detected by a person, said alerting assembly being electrically coupled to said processor and emitting said alert when said processor sends an alert signal to said alerting assembly;
a sensor being mounted in said housing and being in fluid communication with said air intake, said sensor testing the ambient air for an alert agent, said sensor sending an detection signal to said processor when said sensor detects said alert agent, said processor sending said alerting assembly said alert when processor receives said detection signal;
a transmitter being mounted in said housing and being electrically coupled to said processor, said transmitter being configured to be in communication with an extrinsic communication network to contact emergency response personnel;
a power supply being coupled to said housing, said power supply being electrically coupled to said processor, said power supply includes a first power source including a power inlet being configured to be electrically coupled to an electrical power system of a dwelling, said power supply including a second power source comprising a battery, said battery supplying power to said processor when said processor detects a lack of electrical power from said first power source;
a light fixture being remotely positioned with respect to said housing; and
a power outlet extending outwardly from said housing and being electrically coupled to said processor and to said light fixture, said processor turning on said light fixture when said processor detects a lack of electrical power from said first power source.

2. The alarm system according to claim 1, wherein said back wall has a mount thereon configured to engage coupler positioned on a wall surface.

3. The alarm system according to claim 1, wherein said alert agent is smoke or carbon monoxide, said sensor including a smoke detector and a carbon monoxide detector each being mounted in said housing.

4. The alarm system according to claim 3, wherein said alerting assembly includes a speaker, said speaker emitting a smoke alarm when said sensor detects smoke, said speaker emitting a carbon monoxide alarm when said sensor detects carbon monoxide.

5. The alarm system according to claim 1, wherein said alerting assembly includes a strobe light emitting light outwardly from said housing when said alerting assembly receiving said alert signal.

6. The alarm system according to claim 1, wherein said transmitter communicates with the extrinsic communication network when said transmitter receives a transmit signal from said processor, said processor sending said transmit signal after said processor receives said detection signal.

7. (canceled)

8. (canceled)

9. The alarm system according to claim 1, further including an emergency light being coupled to said housing, said emergency light being electrically coupled to said processor, said emergency light being turned on when said processor detects a lack of electrical power from said first power source.

10. An alarm system configured to alert a person to an emergency condition, said alarm system comprising:
a housing having a front wall, a back wall and a perimeter wall extending between and being attached to said front wall and said back wall, said housing having an air intake extending into an interior of said housing to allow ambient air into said housing, said back wall having a mount thereon configured to engage a coupler positioned on a wall surface;
a processor being mounted in said housing;
an alerting assembly being mounted on said housing and emitting an alert comprising a detectable audio or visual output configured to be detected by a person, said alerting assembly being electrically coupled to said processor and emitting said alert when said processor sends an alert signal to said alerting assembly;
a sensor being mounted in said housing and being in fluid communication with said air intake, said sensor testing the ambient air for an alert agent, said sensor sending an detection signal to said processor when said sensor detects said alert agent, said processor sending said alerting assembly said alert when processor receives said detection signal, said alert agent being smoke or carbon monoxide, said sensor including a smoke detector and a carbon monoxide detector each being mounted in said housing;
said alerting assembly including a speaker, said speaker emitting a smoke alarm when said sensor detects smoke, said speaker emitting a carbon monoxide alarm when said sensor detects carbon monoxide;
said alerting assembly including a strobe light emitting light outwardly from said housing when said alerting assembly receiving said alert signal;
a transmitter being mounted in said housing and being electrically coupled to said processor, said transmitter being configured to be in communication with an extrinsic communication network to contact emergency response personnel, said transmitter communicating with the extrinsic communication network when said transmitter receives a transmit signal from said processor, said processor sending said transmit signal after said processor receives said detection signal;
a power supply being coupled to said housing, said power supply being electrically coupled to said processor, said power supply including a first power source including a power inlet being configured to be electrically coupled to an electrical power system of a dwelling, said power supply including a second power source comprising a battery, said battery supplying power to said processor when said processor detects a lack of electrical power from said first power source;
a light fixture being remotely positioned with respect to said housing;
a power outlet extending outwardly from said housing and being electrically coupled to said processor and to said light fixture, said processor turning on said light fixture when said processor detects a lack of electrical power from said first power source; and
an emergency light being coupled to said housing, said emergency light being electrically coupled to said processor, said emergency light being turned on when said processor detects a lack of electrical power from said first power source.
